(19) United States
(12) Patent Application Publication
(10) Pub. No.: US 2021/0255988 A1
(43) Pub. Date: Aug. 19, 2021

(54) METHOD OF EMULATING MOBILE DEVICE IN FILE SYSTEM OF COMPUTER FOR FILE TRANSMISSION

(71) Applicant: I/O Interconnect Ltd., Santa Ana, CA (US)

(72) Inventors: Gary Kung, Taipei (TW); Ping Shun Zeung, Taipei (TW)

(21) Appl. No.: 16/792,362

(22) Filed: Feb. 17, 2020

(51) Int. Cl. G06F 16/16; G06F 16/188; G06F 16/176; G06F 9/455

(52) U.S. Cl. CPC G06F 16/16; G06F 16/188; G06F 2009/45579; G06F 9/45558; G06F 16/176

(57) ABSTRACT

A method of emulating a mobile device in a file system of a computer for file transmission includes: enabling a first application program in the computer and a second application program in the mobile device to be running; building a first connection between the computer and the mobile device; transmitting one or more thumbnail files of the mobile device, corresponding to one or more original files respectively, to the computer by the mobile device based on the first connection; creating a quick access shortcut in the file system; displaying the one or more thumbnail files in the file system according to an operation command applied to the quick access shortcut; and transmitting one of the one or more original files from the mobile device to the computer when a second operation command of the computer is applied to a respective one of the one or more thumbnail files.

### BACKGROUND

### 1. Technical Field

The disclosure relates to a method of emulating a mobile device in a file system of a computer for file transmission, more particularly to a method of emulating a mobile device in a file system of a computer as a wireless drive for transmitting files.

### 2. Related Art

With entering the era of intelligent phones, the files such as photos and videos transferred between smart phones and PCs become diverse. The transmission speed of Bluetooth no more meets the demands of users due to large-sized files caused by the high resolution of photos and videos. As a result, alternative transmission methods such as cloud or WIFI are used widely.

Currently, there are two main platforms in the era of intelligent phones, which are iOS and Android systems. File transmission between an iOS system and a PC is much more complicated than file transmission between an Android system and a PC due to differences of file system structures and system authorities between the iOS system and the PC. Although transferring files between smart phones and PCs via cloud drives such as Google Drive or iCloud seems to be an effective method for users, capacities of cloud storages are generally limited with respect to the large-sized files. Moreover, security and privacy of file transferring via cloud drives are also serious issues for users.

### SUMMARY

A method of emulating a mobile device in a file system of a computer for file transmission is disclosed according to one embodiment of the present disclosure. This method includes: enabling a first application program stored in the computer and a second application program stored in the mobile device to be running respectively; building a first connection between the computer and the mobile device; transmitting one or more thumbnail files of the mobile device to the computer by the mobile device based on the first connection, wherein the one or more thumbnail files corresponding to one or more original files respectively; creating a quick access shortcut in the file system by the computer for emulating the mobile device as a wireless drive in the computer; displaying the one or more thumbnail files in the file system according to an operation command applied to the quick access shortcut; and transmitting one of the one or more original files from the mobile device to a target directory of the computer when a second operation command of the computer is applied to a respective one of the one or more thumbnail files.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a diagram illustrating a computer and a mobile device wirelessly communicated with each other according to one embodiment of the present disclosure;

FIG. 2 is a flow chart illustrating a method of emulating a mobile device in a file system of a computer for file transmission according to one embodiment of the present disclosure;

FIG. 3 is an interface diagram of a file system of the computer according to one embodiment of the present disclosure;

FIG. 4 is a detailed flow chart illustrating the method of emulating the mobile device in the file system of the computer for file transmission according to the embodiment of FIG. 2 of the present disclosure;

FIG. 5 is a flow chart illustrating a method of emulating the mobile device in the file system of the computer for file transmission according to another embodiment of the present disclosure;

FIG. 6 is an interface diagram of the file system of the computer according to another embodiment of the present disclosure;

FIG. 7 is an interface diagram of the file system of the computer according to another embodiment of the present disclosure; and

FIG. 8 is a diagram of operation of the mobile device and the computer connected to a dock according to one embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

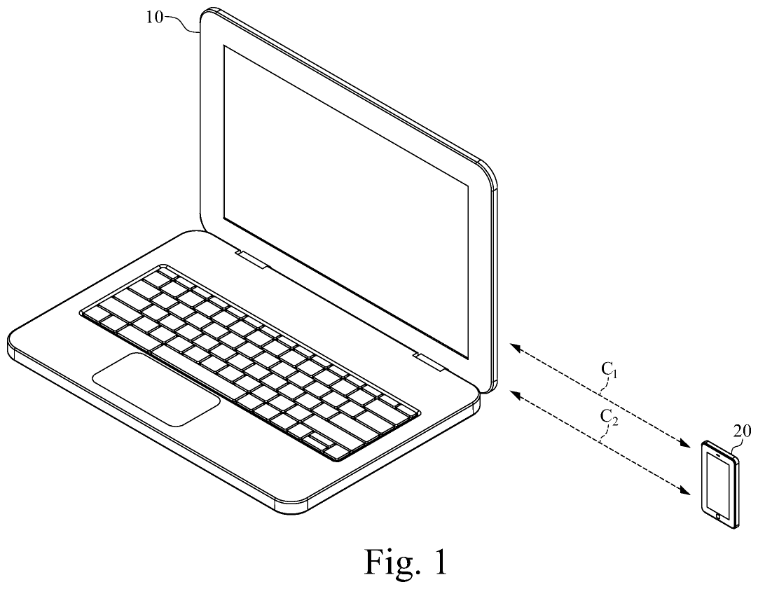

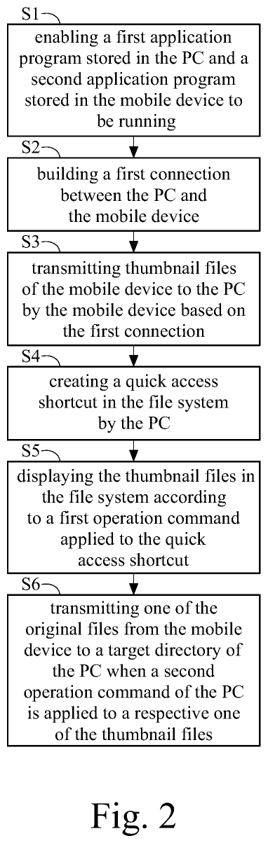

Please refer to FIG. 1 and FIG. 2. FIG. 1 is a diagram illustrating a computer and a mobile device, such as a smartphone or a tablet, wirelessly communicated with each other according to one embodiment of the present disclosure. FIG. 2 is a flow chart illustrating a method of emulating a mobile device in a file system of a computer for file transmission according to one embodiment of the present disclosure. For the purpose of implementing the method disclosed in the present disclosure, first of all, a computer 10 (hereinafter referred as “PC 10”) is installed with a first application program APP1 while a mobile device 20 is installed with a second application program APP2, wherein the mobile device 20 would be either an android-based smartphone or an iOS-based smartphone. However, the type of the mobile device 20 is not limited to the above operating systems in the present disclosure.

As shown in FIG. 1 and FIG. 2, the first application program APP1 stored in the PC 10 and the second application APP2 stored in the mobile device 20 are both enabled to be running, as shown in step S1. Once the first and the second application programs APP1, APP2 both are running, a first connection C1 between the PC 10 and the mobile device 20 is built up as shown in step S2. In an example, the first connection C1 is a wireless connection implemented by techniques such as Bluetooth Low Energy (BLE) or WIFI, but the present disclosure is not limited to this example. In practice, the mobile device 20 is supposed to be within a communication range of the PC 10, or the mobile device 20 and the PC both are within the same communication network, so that the establishment of the first connection C1 could be accomplished. More details regarding the first connection C1 will be described later.

In this embodiment, both of the first application program APP1 and the second application program APP2 would be enabled to be running first, so then the first connection C1 is built up. However, in another example, the above two procedures can be performed in a reverse way; that is, once the first connection C1 is established first, the first application program APP1 and the second application APP2 are both enabled to be running. Specifically, in this another embodiment, the establishment of first connection C1 would be considered as a trigger signal to enable the running of both of the first application program APP1 and the second application program APP2. In practice, the first application program APP1 and the second application program APP2 mentioned above are allowed to be running in the background in the PC 10 while the PC 10 is implementing other functions.

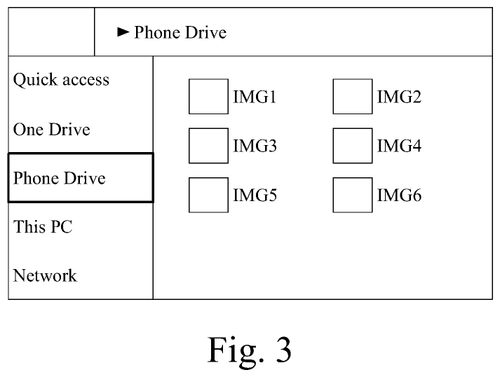

Please further refer to FIG. 3, which is an interface diagram of a file system of the computer according to one embodiment of the present disclosure. In this embodiment, the file system is the well-known Windows File Explorer system installed in the PC 10. It is noted that the first and the second application programs APP1 and APP2 are respectively executed by the processor of the PC 10 and the processor of the mobile device 20 for performing the following tasks.

In a condition in which the first and the second application programs APP1, APP2 are running and the first connection C1 is established, in step S3, the second application programs APP2 of the mobile device 20 transmits thumbnail files IMG1-IMG6 of the mobile device 20 to the PC 10 based on the first connection C1. Specifically, instead of real files, these thumbnail files IMG1-IMG6 are virtual files presented in the file system of the PC 10. Each of the thumbnail files IMG1-IMG6 corresponds to a respective real and original file such as a photo or a video file stored in the mobile device 20. The amount of the thumbnail files IMG1-IMG6 shown in the embodiment is merely used for illustration, and the present disclosure is not limited to the embodiment.

In step S4, a quick access shortcut (e.g. named as “Phone Drive” in FIG. 3) is created in the interface of file system by the first application program APP1 of the PC 10. When these thumbnail files IMG1-IMG6 of the mobile device 20 are transferred to the PC 10, the first application program APP1 of the PC 10 would create the quick access shortcut serving as an icon used for emulating the mobile device 20 as a wireless drive in the PC 10. This quick access shortcut is substantially considered as a link between the PC 10 and the mobile device 20.

In step S5, the first application program APP1 of the PC 10 displays the thumbnail files IMG1-IMG6 in the interface of file system according to a first operation command applied to the quick access shortcut. The first operation command could be, for example, given by a processor within the PC 10 as the user operates an input device of the PC 10, such as a keyboard and/or a mouse. Specifically, as shown in FIG. 3, the interface of the file system would display thumbnail files IMG1-IMG6 when the user clicks/operates on the icon of the quick access shortcut. As described above, these thumbnail files IMG1-IMG6 are merely virtual files without containing any meaningful file data, which are provided for the user to have a quick review. The user is allowed to conveniently review which files are included in the mobile device 20 in a condition in which the storage of the PC 10 would not be significantly occupied by the thumbnail files IMG1-IMG6.

In step S6, one of the original files are transmitted from the mobile device 20 to a target directory of the PC 10 when a second operation command of the PC 10 is applied to a respective one of the thumbnail files IMG1-IMG6. In detail, the processor of the PC 10 generates the first file transmission command as the user copies/pastes or drags/drops any of thumbnail files IMG1-IMG6. For example, when the user copies the thumbnail file IMG1 and further pastes on a target directory of the PC, the first application program APP1 of the PC 10 would ask the second application program APP2 for uploading the original file corresponding to the thumbnail file IMG1, and this original file will be further transferred from the mobile device 20 to the target directory of the PC 10 via the first connection C1 or another connection which is further built based on the first connection C1.

That is, the original files containing meaningful file data are transferred from the mobile device 20 to the PC 10 only when the second operation command is given by the processor as the user performs operations of copy/paste or drag/drop on the thumbnail files.

By using the method of emulating files of the mobile device 20 in the present file system of the PC 10 as disclosed in the present disclosure, files demanded by the user could be easily transferred between the mobile device 20 and the PC 10 via local transmitting technique without significantly consuming the storage capability of the PC 10, which providing a much more secure way for file transmissions than the file transmitting technique via a cloud drive.

In one embodiment, the method of FIG. 2 further includes the first application program APP1 of the PC 10 marks one of the thumbnail files IMG_1-ING_6 as offline when the original file in the mobile device 20 corresponding to this thumbnail file is not fully synchronized in the PC 10 due to a failure of the first connection C1 between the PC 10 and the mobile device 20. A practical example is given in the following paragraph for illustrating the above embodiment.

Assume that the user performs an operation of copy/paste or drag/drop on the thumbnail files IMG_3 for transmitting the original file corresponding to the thumbnail file IMG_3 from the mobile device 20 to the PC 10. Due to some reasons (e.g. technical problems or weak signal strengths), the first connection C1 may fail during the transmission process of the original file from the mobile device 20 to the PC 10. In this case, the synchronization of the original file is not completed in the PC 10. Accordingly, the first application program APP1 of the PC 10 will mark the icon of the thumbnail files IMG_3 as “offline”, so that the user could immediately know that the original file of the thumbnail files IMG_3 is not transferred to the PC 10 successfully.

In practice, this “offline” icon will be removed automatically once the first connection C1 is restored and the transmission process of the original file from the mobile device 20 to the PC 10 is further proceeded.

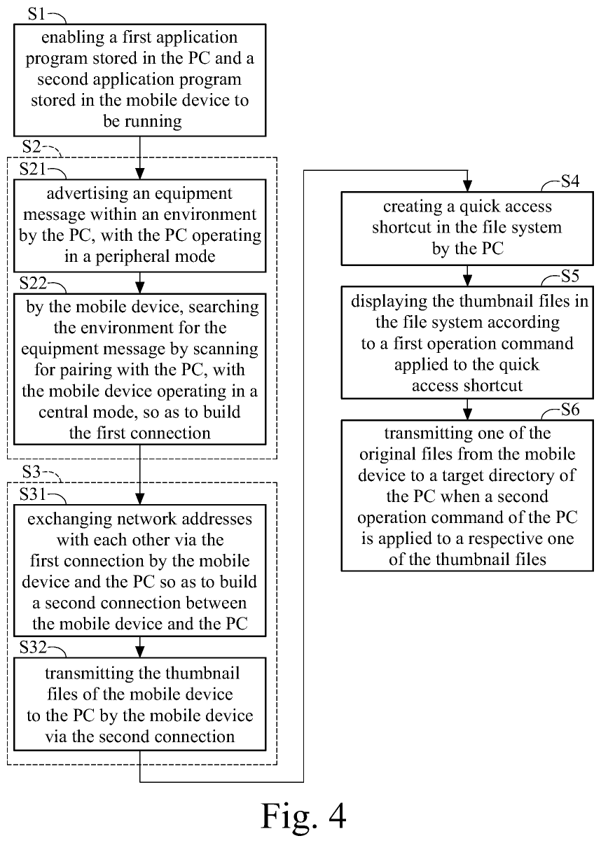

Please refer to FIG. 4, which is a detailed flow chart illustrating the method of emulating the mobile device in the file system of the computer for file transmission according to the embodiment of FIG. 2 of the present disclosure. Steps S1, S4-S6 shown in the embodiment of FIG. 4 are basically the same as steps S1, S4-S6 shown in the embodiment of FIG. 2. However, details of steps S2 and S3 are further shown in FIG. 4. Specifically, there are sub-steps S21 and S22 in step S2, while there are sub-steps S31 and S32 in step S3.

In sub-step S21, the first application program APP1 of the PC 10, operating in a first mode, advertises an equipment message within an environment. In this embodiment, the equipment message includes one or more advertisement packets associated with the PC 10. By advertising the equipment message in the environment, the PC 10 notifies the other device (e.g. the mobile device 20) of its existence.

In sub-step S22, the second application program APP2 of the mobile device 20, operating in a second mode, searches the environment for the equipment message by scanning for being paired with the PC 10, so as to build the first connection C1 which is a BLE connection in this embodiment. In practice, the mobile device 20 should be located within a range of the PC 10, so that the second application program APP2 of the mobile device 20 is capable of discovering the existence of the PC 10 in the environment. In one embodiment, in the case that the first connection C1 is built based on Bluetooth (e.g. BLE) technique, the first mode would be a peripheral mode while the second mode would be a central mode.

Once the first connection C1 which is the BLE connection is established, a second connection C2 can be further built based on the BLE connection as shown in FIG. 1. The second connection C2 is, for example, a WIFI connection having a communication protocol different from that of the BLE connection. More specifically, in sub-step S31, the mobile device 20 and the PC 10 exchange network addresses with each other via the first connection C1, so as to build the second connection C2 between the mobile device and the PC 10. The network addresses include IP address of the PC 10 and the mobile device 20. In other words, the PC 10 and the mobile device 20 exchanges their own IP addresses with each other, so that the second connection C2 which is a WIFI connection can be built.

When the second connection C2 which is a WIFI connection is built, in sub-step S32, the second application program APP2 of the mobile device 20 transmits the thumbnail files IMG1-IMG6 of the mobile device 20 to the PC 10 via the second connection C2 (WIFI connection). In this embodiment, once the second connection C2 is built up according the first connection C1, the original files also can be transmitted from the mobile device 20 to the target directory of the PC 10 via the second connection C2.

In one embodiment, the method of FIG. 2 further includes that the mobile device 20 sends a file list to the PC 10, the first application program APP1 of the PC 10 determines whether any of the original files has already existed in the PC 10 with the file list, and the first application program APP1 of the PC 10 further updates the status of the thumbnail files. Specifically, the first application program APP1 of the PC 10 sends a request to the mobile device 20 in order to ask for a file list of the mobile device 20, and the mobile device 20 would send back the file list to the PC 10 in response to the request. The file list includes the information of a plurality of files related to the mobile device 20. By comparing the local files of the PC 10 with the files included in the file list of the mobile device 20, the first application program APP1 of the PC 10 is capable of determining which files of the mobile device 20 have already existed in the PC 10, and further updates the status of the thumbnail files, so that the user can decide which file to be transferred from the mobile device 20 to the PC10.

In one of implementations, by using the file list of the mobile device 20 to be compared with the current local files of the PC 10, the PC 10 determines that the original files corresponding to the thumbnail files IMG 1, IMG 3 and IMG 5 have been previously transferred to and already existed in the PC 10. In this implementation, for the purpose of updating the file status, the icons of the thumbnail files IMG 1, IMG 3 and IMG 5 displayed in the file system of the PC 10 would be labelled as “download completed”. By viewing the status of each of the thumbnail files shown in the interface of the file system, the user is able to know the original files of the thumbnail files IMG 1, IMG3 and IMG 5 have been already transferred from the mobile device 20 to the PC 10. In this case, the user may decide to transfer the original files of the rest thumbnail files IMG 2, IMG4 and IMG6.

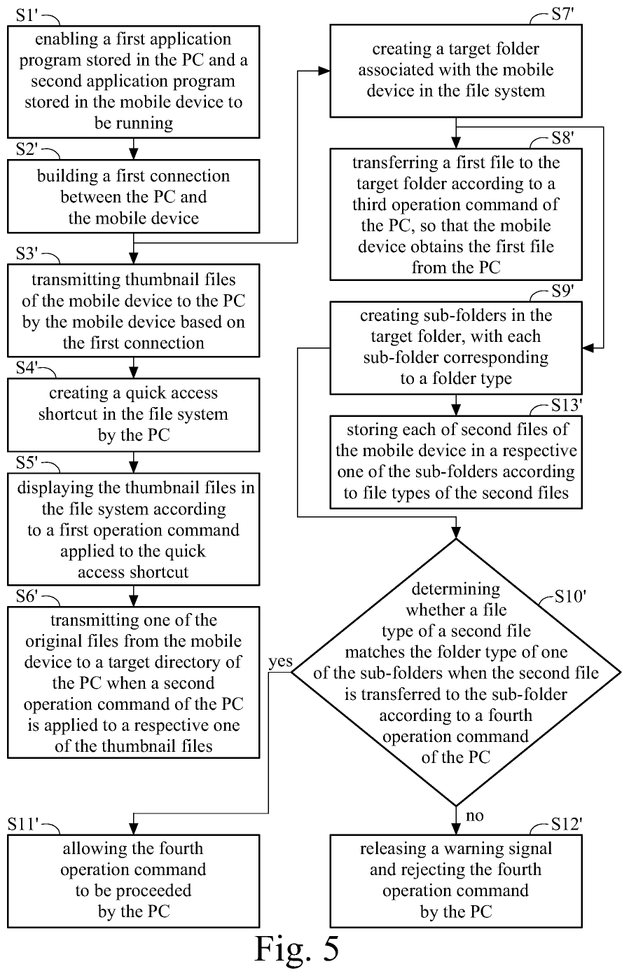

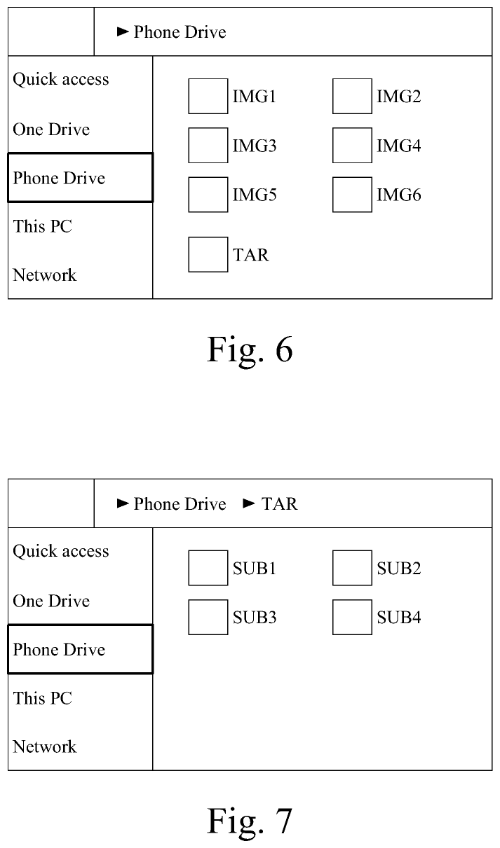

Please refer to FIG. 5 and FIG. 6. FIG. 5 is a flow chart illustrating a method of emulating the mobile device in the file system of the computer for file transmission according to another embodiment of the present disclosure. FIG. 6 is an interface diagram of the file system of the computer according to another embodiment of the present disclosure.

The method shown in FIG. 5 includes steps S1′-S6′ identical to steps S1-S6 of the method shown in FIG. 2. Further, the method of FIG. 5 includes steps S7′-S13′. Specifically, after both of the first application program APP1 and the second application program APP2 are enabled to be running (step S1′) and the first connection C1 is built (step S2′), steps S7′-S13′ could be implemented as shown in FIG. 5.

Specifically, in one embodiment, in addition to the above-mentioned thumbnail files IMG1-IMG6, in step S7′, the first application program APP1 of the PC 10 creates a target folder TAR associated with the mobile device 20 in the file system, as shown in FIG. 6. The file system not only displays the thumbnail files IMG1-IMG6, but also displays the target folder TAR when the icon of the quick access shortcut named “Phone Drive” is clicked. In step S8′, a first file is transferred to the target folder TAR according to a third operation command, so that the mobile device 20 obtains the first file from the PC 10. Specifically, the PC 10 would send the third operation command as the user copies/pastes or drags/drops the first file, for asking the second application program APP2 of the mobile device to get the first file through the target folder TAR. Accordingly, the first file would be transmitted from the PC 10 to the mobile device 20 (via the first connection C1 or the second connection C2) since the target folder TAR of the mobile device 20 is substantially linked to the mobile device 20 and emulated as a wireless storage space in the file system of the PC 10.

Pleaser further refer to FIG. 7, which is an interface diagram of the file system of the computer according to another embodiment of the present disclosure. In one embodiment, in step S9′, a plurality of sub-folders S-SUB4 are created in the target folder TAR by the first application program APP1 of the PC 10, as shown in FIG. 7. When the user clicks on the icon of the target folder TAR, theses sub-folders SUB1-SUB4 would be displayed in the file system of the PC 10. In this embodiment, each the plurality of sub-folders SUB1-SUB4 corresponds to a folder type. For example, the sub-folder SUB1 corresponds to a folder type of “PHOTO/VIDEO”, the sub-folder SUB2 corresponds to a folder type of “PDF”, the sub-folder SUB3 corresponds to a folder type of “WORD” and the sub-folder SUB4 corresponds to a folder type of “POWERPOINT”.

In step S10′, the first application program APP1 of the PC 10 determines whether a file type of a second file matches the folder type of one of the sub-folders SUB1-SUB4 when the second file is transferred to the sub-folder according to a fourth operation command of the PC 10.

When it is determined that the file type of the second file matches the folder type of the sub-folder to which the second file is transferred, in step S11′, the first application program APP1 of the PC 10 allows the fourth operation command to be proceeded and accordingly the second application program APP2 of the mobile device 20 is capable of obtaining the second file from the PC 10. When it is determined that the file type of the second file does not match the folder type of the sub-folder to which the second file is transferred, in step S12′, the first application program APP1 of the PC 10 releases a warning signal and rejects the fourth operation command. In this case, the second file is not transferred to the sub-folder successfully, so the second application program APP2 of the mobile device 20 could not obtain the second file from the PC 10.

In one embodiment, as shown in FIG. 5, the method further includes steps S13′. In step S13′, the second application program APP2 of the mobile device 20 stores each of a plurality of second files of the mobile device 20 in a respective one of the plurality of sub-folders according to file types of the plurality of second files. For example, if a second file has a file type of “pdf”, then this second file would be stored in the sub-folder SB2 which has the folder type of “PDF”. In another example, if a second file with a file type of “photo”, then this second file would be stored in the sub-folder SB1 which has the folder type of “PHOTO/VIDEO”.

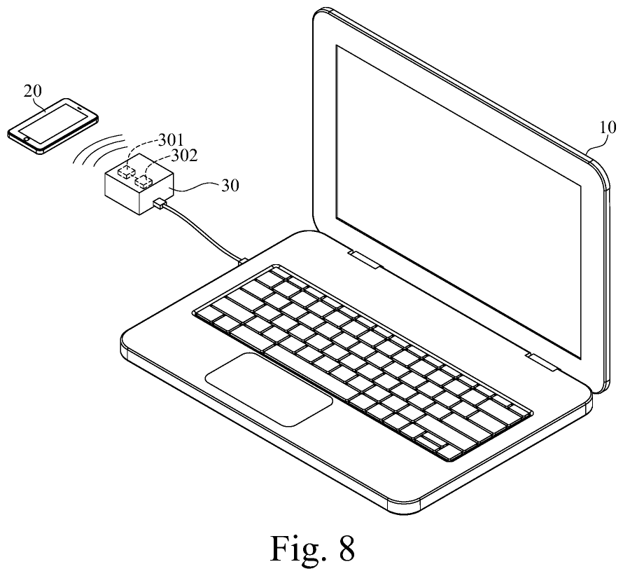

Please refer to FIG. 8, which is a diagram of operation of the mobile device and the computer connected to a dock according to one embodiment of the present disclosure. In this embodiment, the computer 10 is connected to a dock 30 which has a BLE device 301 and a micro-processing unit 302 connected to each other. More specifically, the computer 10 is connected to the dock via a physical cable such as a USB cable. Before performing step S1 in FIG. 2 of enabling the first application program APP1 stored in the PC 10 and the second application program APP2 stored in the mobile device 20 to be running respectively, the method of FIG. 2 further includes detecting whether the mobile device is within a range of signal strength by the BLE device 301 in the dock 30; and triggering the first application program APP1 of the computer 10 and the second application program APP 2 of the mobile device 20 when the BLE device 301 of the dock 30 determines the mobile device is located within the range of signal strength. More details will be described below.

In the operation of this embodiment, the micro-processing unit 302 such as a microprocessor would make sure that the dock 30 is accurately connected to the computer 10, so that signals or data can be transmitted between the dock 30 and the computer 10. Further, the BLE device 301 will be advertising packets within the range of signal strength around the environment. Once the mobile device 20 enters the strength range of the BLE device 301, the BLE module of the mobile device 20 discovers the dock 30 by scanning the packets advertised by the BLE device 301 of the dock 30. At this moment, the mobile device 20 sends a request to the dock 30 for pairing. Accordingly, the BLE device 301 of the dock 30 detects that the mobile device 20 is located within the range of signal strength and drives the micro-processing unit 302 to generate a trigger signal to enable the APP 1 of the PC 10 to run while the BLE module of the mobile device 20 triggers the APP 2 of the mobile device to run, which means the BLE beacons trigger both the APPs to run.

In view of the foregoing descriptions, by implementing the method disclosed in the present disclosure, files of a mobile device can be emulated in the present Windows Explorer File system of a computer. By operating on the present Windows Explorer File system, file transmission between the mobile device and the computer could be achieved by a user in an intuitive way. Since the file transmission is performed between the mobile device and the computer without utilizing cloud drives, the problems of information security and privacy can be overcome. Furthermore, the method can be applied to any type of mobile devices installed with either Android or IOS system platforms, so as to achieve the purpose of the cross-platform file transmission.

What is claimed is:

1. A method of emulating a mobile device in a file system of a computer for file transmission, comprising:
enabling a first application program stored in the computer and a second application program stored in the mobile device to be running respectively;
building a first connection between the computer and the mobile device;
transmitting one or more thumbnail files of the mobile device to the computer by the mobile device based on the first connection, wherein the one or more thumbnail files correspond to one or more original files stored in the mobile device respectively;
creating a quick access shortcut in the file system by the computer for emulating the mobile device as a wireless drive connecting to the computer;
displaying the one or more thumbnail files in the file system according to a first operation command applied to the quick access shortcut; and
transmitting one of the one or more original files from the mobile device to a target directory of the computer when a second operation command of the computer is applied to a respective one of the one or more thumbnail files.

2. The method according to claim 1, wherein building a first connection between the computer and the mobile device comprises:
advertising an equipment message within an environment by the computer, with the computer operating in a first mode; and
by the mobile device, searching the environment for the equipment message by scanning for pairing with the computer, with the mobile device operating in a second mode, so as to build the first connection.

3. The method according to claim 2, wherein transmitting the one or more thumbnail files of the mobile device to the computer by the mobile device based on the first connection comprising:
exchanging network addresses with each other via the first connection by the mobile device and the computer so as to build a second connection between the mobile device and the computer; and
transmitting the one or more thumbnail files of the mobile device to the computer by the mobile device via the second connection, wherein a communication protocol of the second connection is different from a communication protocol of the first connection.

4. The method according to claim 1, further comprising:
creating a target folder associated with the mobile device in the file system; and
transferring a first file to the target folder according to a third operation command of the computer, so that the mobile device obtains the first file from the computer.

5. The method according to claim 4, further comprising:
creating a plurality of sub-folders in the target folder, with each the plurality of sub-folders corresponding to a folder type; and
storing each of a plurality of second files of the mobile device in a respective one of the plurality of sub-folders according to file types of the plurality of second files.

6. The method according to claim 4, further comprising:
creating a plurality of sub-folders in the target folder, with each of the plurality of sub-folders corresponding to a folder type;
determining whether a file type of a second file matches the folder type of one of the plurality of sub-folders when the second file is transferred to the sub-folder according to a fourth operation command of the computer; and
releasing a warning signal and rejecting the fourth operation command by the computer when the file type of the second file does not match the folder type of the sub-folder to which the second file is transferred.

7. The method according to claim 1, further comprising:
detecting whether the mobile device is within a range of signal strength by a BLE device in a dock which is connected to the computer via a cable; and
triggering the first application program of the computer and the second application program of the mobile device when the BLE device of the dock determines the mobile device is located within the range of signal strength.

8. The method according to claim 1, further comprising:
marking one of the one or more thumbnail files as offline when the original file in the mobile device corresponding to the thumbnail file is not fully synchronized in the computer due to a failure of the first connection between the computer and the mobile device.

9. The method according to claim 1, further comprising:
sending a file list to the computer by the mobile device;
determining whether any of the one or more original file has already existed in the computer with the file list by the computer; and
updating status of the one or more thumbnail files by the computer.
